(19) United States
(12) Patent Application Publication
(10) Pub. No.: US 2006/0196260 A1
(43) Pub. Date: Sep. 7, 2006

(54) Simple method and apparatus for quickly and accurately determining pressure points imposed on the foot by a ski boot

(76) Inventor: C.S. Khajavi, Los Angeles, CA (US)

Correspondence Address: C. S. Khajavi, Apt. #202, 1377 S. Beverly Glen Blvd., Los Angeles, CA, 90024, US

(21) Appl. No.: 11/368,493

(22) Filed: Mar. 7, 2006

Related U.S. Application Data
(60) Provisional application No. 60/658,749, filed on Mar. 7, 2005.

(51) Int. Cl. G01M 19/00

(52) U.S. Cl. 73/172

(57) ABSTRACT

A method and apparatus is disclosed for improved selection and fitting of shoes, boots and athletic footwear, such as ski boots. This invention provides a method and apparatus to ensure no pressure is applied to the toes; no pressure-less areas exist where there is supposed to be pressure, thus ensuring a more snug fit. The method comprises of wearing socks with inner protrusions or wearing a mesh sock that leave impressions on the skin when pressure is applied to the sock and the foot by the boot.

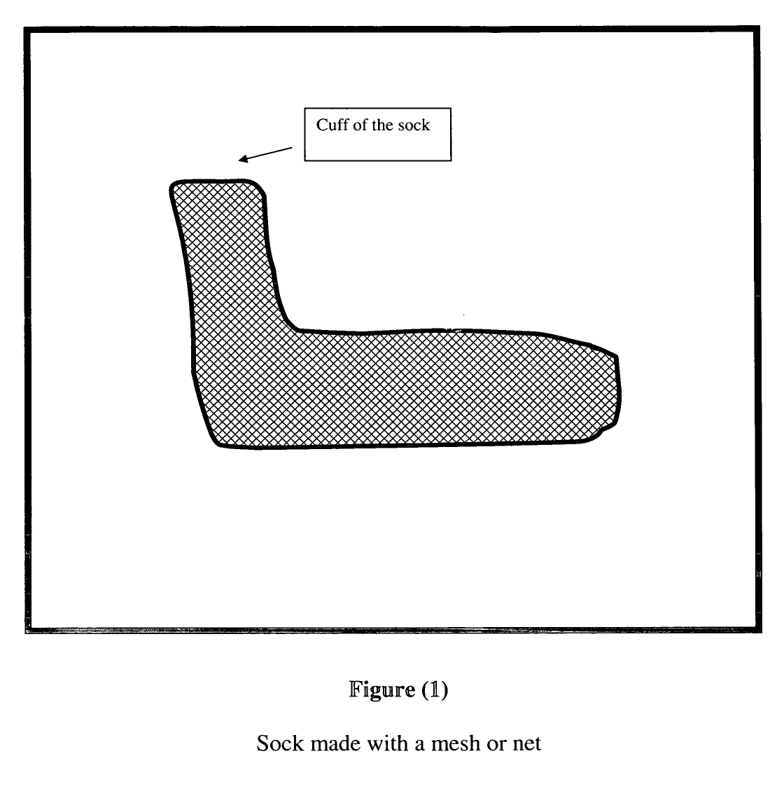

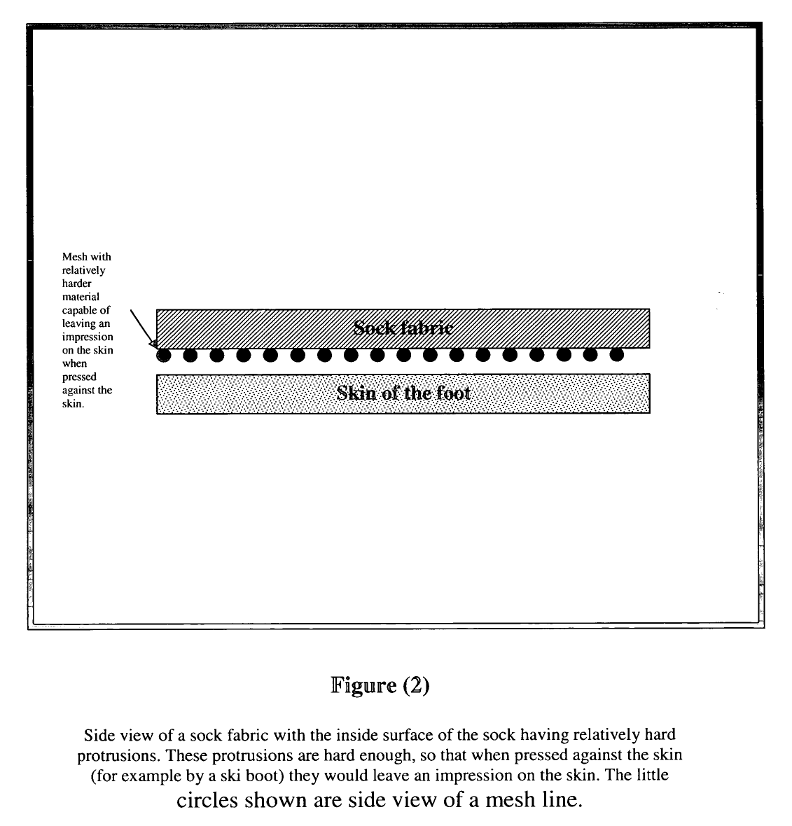

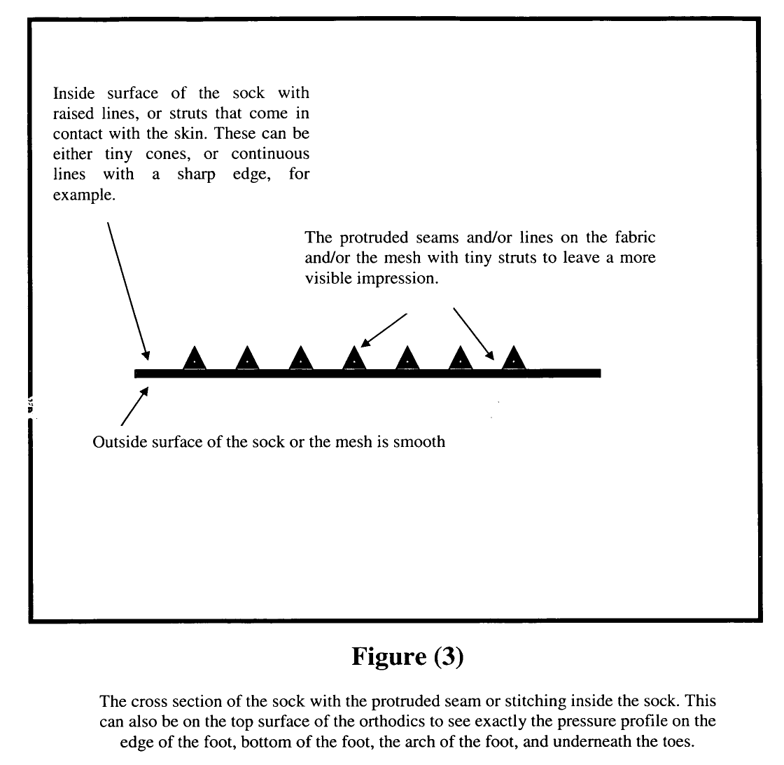

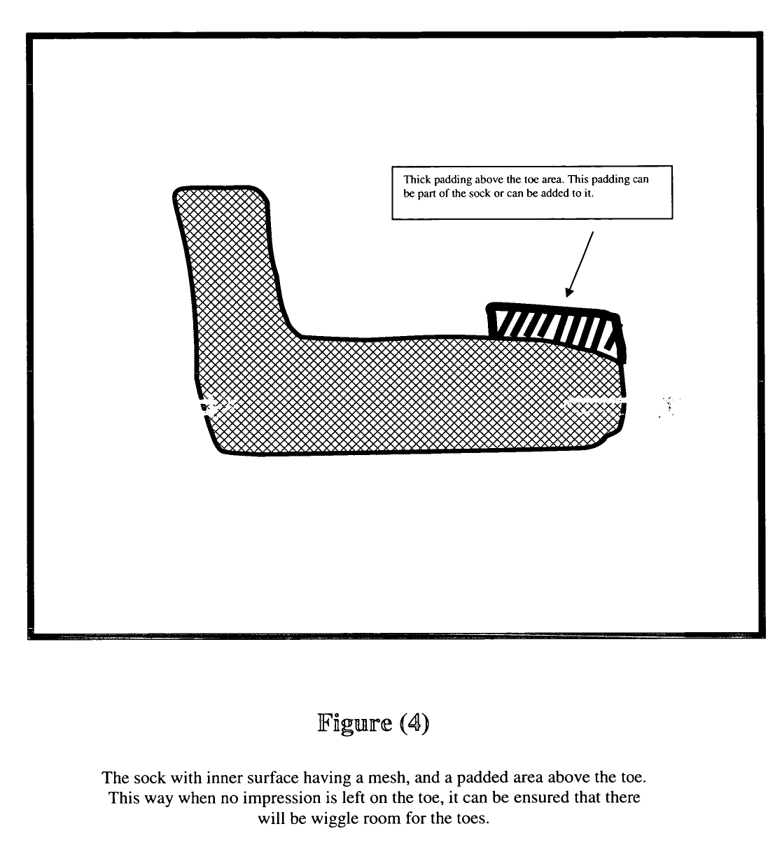

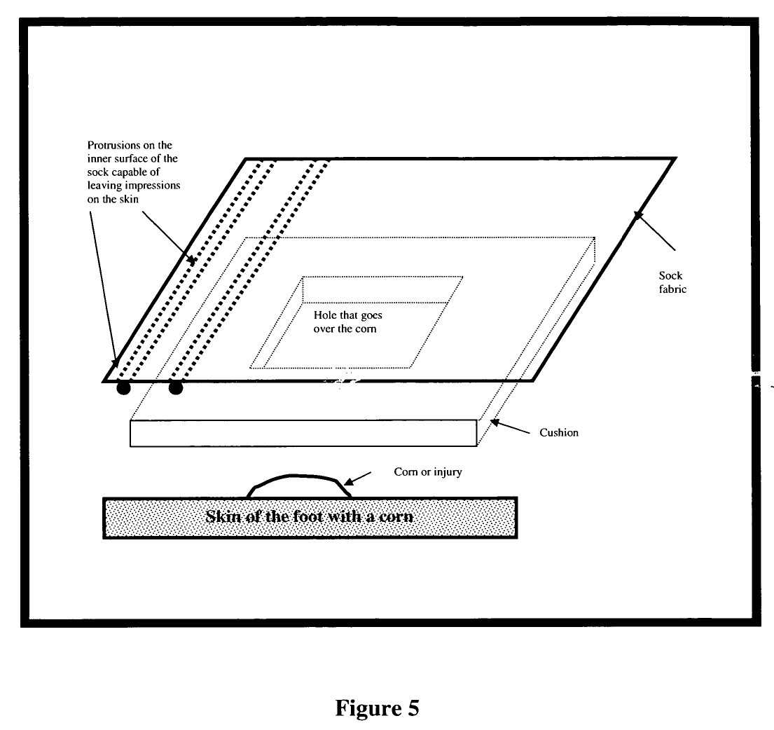

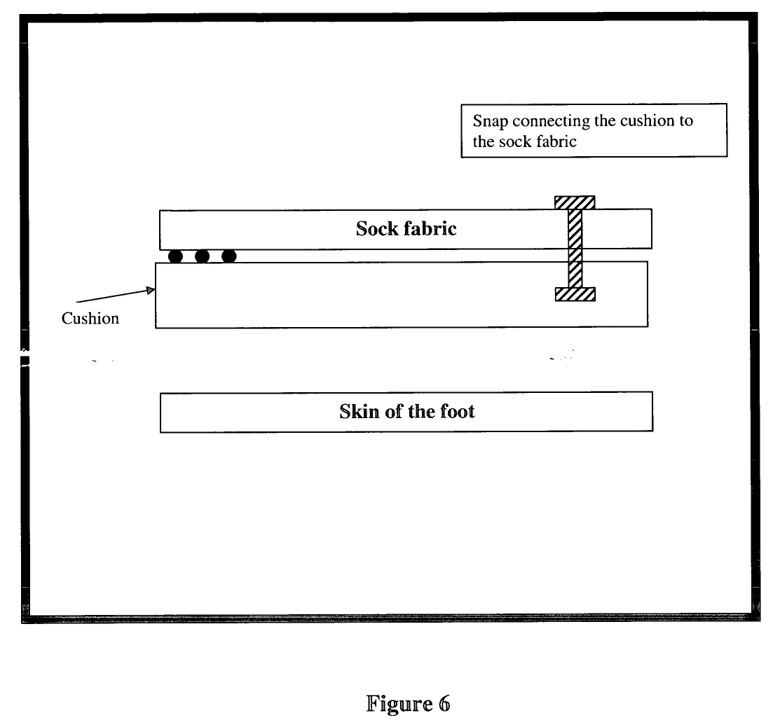

### FIELD OF INVENTION

Ski boots are the most important part of a skier's equipment. Nothing we wear is as unnatural, hard, heavy, and bulky as ski boots. A skier's comfort and control depends on ski boots that fit just right. Furthermore, ski boots have become expensive, making it imperative that no mistakes are made in choosing the right size.

Tight ski boots can lead to pain, numbness, reduced blood circulation, pinched nerves, and injury to the skin, muscles, and bones of the foot, ankles, and toes. Tight ski boots applying direct pressure on the toes, can also damage the toenails only after a few runs of skiing.

Loose ski boots can lead to injuries when the foot slides back and forth or sideways and bumps against the inside of the ski boot. Loose fitting ski boots can also lead to loss of toenails because of repeated striking of the toenails to the front of the ski boot. Loose fitting ski boots are also unsafe since they reduce a skier's control and can thus lead to accidents on the slope.

### OBJECT OF THE INVENTION

The object of this invention is to provide a means and method and apparatus to make it possible to have properly fitted ski boots and other athletic or ordinary shoes and footwear. Properly fitted ski boots are the single most important factor in safe skiing. Without a snug (but not too tight) fit, the pressure exerted by the motion and lateral movement of skiing will result in discomfort and possible injury. Only a right fitting ski boot can provide both the comfort and the control needed in demanding sports such as skiing.

Benefits of the right fitting ski boots are:
Safety on slope due to better control.
Avoiding long term and short term foot injuries.
Improved skiing performance.
More skiing, quantitatively, since the skier can ski more by getting tired less.
More skiing, qualitatively, due to more comfort and pleasure while skiing.

The right size and right fitting ski boot is one which is neither tight nor loose. The right ski boots do not have any uncomfortable, localized pressure points and are snug evenly and uniformly in the desired areas of the foot. The desired areas where even and sung pressure is desired are the bottom edges of the foot, the top of the foot, the ankle area, the Achilles' heel area, and the bottom of the foot. The area where no pressure or little pressure is desired are the toes and toenails. Toes are delicate and vulnerable. When pressure is applied to the toes, they can quickly be bruised and injured. Bruised toenails first get black and blue and then fall off after a few days and take months to regenerate. When the foot is subject to extreme colds the toes are the first part of the foot to suffer from frostbite. The combination of cold weather and reduced blood flow to any of the five toes accelerates the frostbite process.

Often the discomfort or numbness in one part of the foot is caused by pressure being applied to a different part of the foot, which can be far from the place on foot where the discomfort is felt. For example numb toes can be caused not only by direct pressure on the toes themselves, but also pressure applied to the top of the foot close to the ankles where there is a cluster of nerves and veins that extend to the toes.

It is thus important to know exactly where the pressure points are, and just as importantly where there are no pressure points. This is important whether selecting an off-the-shelf boot, or when making custom-made, foam-injected boot, or when making orthodics for the boot.

Today, the process of determining the pressure points imposed on the foot by a ski boot is inexact and time-consuming. The skier must wear the boots for an extended period of time, and then tell the boot fitter where she or he “thinks” the pressure points are. The ski boot is made of thick and heavy plastic and often the person wearing the boot can feel the pain or the discomfort, but can't tell where the pressure point are exactly. The process of wearing the boot, then expanding the boot, or milling/shaving the liner of the boot, may take several iterations and often the wrong area of the boot is expanded making the boot unsuitable for use all together.

Since children have less perception and less communication ability, the process of knowing and communicating where the pressure points are is made even more difficult when the boots are being fitted or selected for them.

Finally, even if the perfect size boot is selected off the shelf or custom made, it is still important to know how much each buckle of the ski boot should be tightened to achieve the optimal balance between comfort and control.

Another major merit of this invention is that in places in the ski boot where the liner has give, or where there is no pressure (where pressure is supposed to be), the ski boot technician, using this invention can determine the width, size and shape of the shim needed to fill the space where pressure needs to be. (shim is a niece of material used to fill in space between things).

The Psychological Factor

What is happening inside the big bulky ski boot is for the most part unknown. If you ask any skier if they would like to see the pressure distribution on their foot, they would most likely give you a positive answer. There is a psychological benefit in knowing what the exact interaction between the boot and one's foot is. It is important to know where the contacts points are and to know how forces are transferred from the legs and the feet to the skis. The more the skier knows about the interaction of their body and their equipment, the better.

### PRIOR ART

Various methods have been proposed to identify and determine the pressure being applied to the foot by a shoe or boot. These methods include:

1. Using microcapsules like a bubble wrap with small bubbles that have dye in them. Upon pressure the bubbles burst and release ink on the skin. This way it is determined where the pressure is.

2. Using a specially made sock that has dye embedded into the fabric. The sock is made such that when pressure is applied to it, dye is released on the skin.

3. More high-tech methods have been proposed where piezoelectric (a.k.a. piezo-resistive) materials are used that generate electricity when pressure is applied to them.

These methods and apparatus are complicated, expensive, not for mass public use, inaccurate, messy, and unnecessarily complicated.

The invention disclosed here, is extremely easy, fast and simple. and can be done even by a child.

### DESCRIPTION OF THE INVENTION

The solution to the problem of making or selecting ski boots that are neither tight nor loose, consists of an apparatus and a method.
1. The apparatus is a special sock that leaves impressions on the skin of the foot where there is pressure being applied by the ski boot.
2. The method is the process of visual inspection of the impressions made on the skin to know:
   A. Where pressure is applied.
   B. How much pressure is applied.
   C. Where no pressure is applied.

With above it is possibly to quickly establish a pressure profile/map on the foot imposed by the ski boot.

### THE METHOD AND APPARATUS

The invention disclosed herein (with the trademark of “Achilles' HeAl”) is a special sock that is made of a mesh or a net, or a mesh or a net that is woven inside a sock. Mesh or a net is a material of open texture with spaced holes. The mesh or the net should ideally be hard enough to leave easily visible impressions on the foot. For example it can be made of plastic with approximately half a millimeter in thickness. And for example the mesh's openings can be three millimeters in diameter, if they are circular openings. A mesh is ideal since it leaves impressions on the skin where it comes in contact with the skin; and where there are the mesh openings the skin and the flash protrude out. This pattern of grooves and protruded skin and flesh, allows for an easy, quick, and simple visual inspection to determine where the pressure is applied, how much pressure is applied, and where there little or no pressure is applied.

Ideally, the mesh should be woven and integrated into the inner surface of a sock. This makes the sock more pleasing to the eye, and makes it easier to wear and take off. It also allows for the sock to be worn while skiing and will keep the feet warm doing so.

The ideal ski boot fitting sock is:
A. Not too soft—to leave a pronounced impression. Furthermore, being hard makes the sock uncomfortable which makes it easier to feel the pressure areas with more accuracy even before the socks are taken off.
B. Have small holes to have a fine resolution to allow for detecting small pressure points. For example a small pressure point can exist on the little toe, leading to a blister. The holes can be made like honeycomb for esthetic purposes.
C. Come in different sizes, so men and women of all ages and sizes can benefit from it.
D. Be elastic or have elastic seams or strips, so that the socks are easy to put on and take off, and so that when worn, the socks conform to the shape of the foot.
E. Has sharpness in the mesh to leave a poignant impression where it comes in contact with the skin. Also the sharpness makes the sock a little uncomfortable, making it easier to feel where the pressure points are even before the ski boots are taken off.
F. Has a very thick toe area. The thickness can be achieved by using heavier fabric to construct the toe area, or it can be applied to the sock by gluing, ironing, sewing, or using snaps, or Velcro to attach a thick piece of material over and above the toe area. The sock should leave any impression on the toes, even with the thicker toe box area. This ensures that when the skier is wearing normal ski socks, she or he has enough wiggle room for the toes, which is very desirable, and can help blood circulation and thus keep the toes warm and comfortable and less likely to be injured.

Isolating and Protecting Injured or Painful Areas of the Foot:

In another embodiment of the invention, provides for a means to keep pressure away from sensitive areas. Currently commercial products exist that do this. Example is Dr. Scholl's Corn Cushions, that using adhesives, adhere to the skin. These are tiny doughnut or round shaped cushions that are placed on the skin such that the corn gets positioned inside the hole. They isolate and then protect the corn from pressure. The walls of the cushion take the brunt of the pressure of the shoes and do not allow any pressure to be applied to the corn, thus reducing pain. To isolate and protect, calluses, and corns, a padded material can be attached to the inside of the socks disclosed in this invention. In other words, instead of a donut shaped cushion being placed on the skin, the donut or round shaped cushion can be attached to the inside of the sock. When the sock is worn the cushion will protect the callus or place of injury.

Generally, it is harder to make an impression on the bottom of the foot that it is on the top of the foot. This is because there is more fat and muscle between the skin and the bones at the bottom of the feet than there is at the top of the feet. Furthermore, the skin at the bottom of the feet is much thicker than the skin on top. For this reason, ideally, the mesh, at the bottom surface where it comes in contact with the bottom of the feet and the arch of the feet, should be made such that it leaves more poignant impressions. For example, either it should be thicker or have something on it that is pointed that almost penetrates the skin. Examples are tiny cones on the surface of the mesh where it comes in contact with the skin at the bottom of the feet (note: it is best to see the pressure applied to the bottom of the feet, when the skier is sitting down and not standing up).

In another more elaborate embodiment of the invention, the sock is made according to the different areas of the foot. For example, one can divide the foot into eight areas as follows:
1. The toe area—where there should be no pressure whatsoever from the sides, or top or bottom. The toe and the toenails suffer most of all foot injuries.
2. The top of the foot—where it is easy to leave impressions on the skin.
3. The ankles—where the boot needs to fit snug since this is the place most force is transferred from the foot to the ski. This area includes the Achilles' heel area.
4. The edge of the foot—imagine a footprint on the sand on the beach. By the edge of the foot it is meant the part of the boot that makes the edge of the footprint and going up for about half an inch.
5. The bottom of the foot (including the arch of the feet). This area is extremely important since this is where the orthodics come in contact with. Badly designed orthodics can actually lead to more injuries and can be counter productive. Making the orthodics is the very first step in fitting the boot. Like a house with a bad foundation that can never be build right, a poorly made orthodics with the wrong pressure points (or places of no pressure), can throw off the entire subsequent fitting process of the boot.
6. Calves
7. The shins
8. The toenails

The boot sock can be made to have different characteristic from one place to another depending on what part of the eight regions of the foot mentioned above it comes in contact with. Different characteristics could be different thickness, or materials or the presence of sharp and pointed cones or lines.

In another embodiment of the invention, the sock can be exactly like an ordinary sock, except that only one (or several) portions of it could be a mesh as opposed to all being a mesh. For example, the sock could be like a dress sock, and only the mesh section will be the part that comes in contact with the toes. This sock could be useful in ensuring that there is no pressure applied to the toes so that the toes are free to wiggle and move inside the sock and enjoy full blood circulation; and the toenails are not being damaged.

In another embodiment of the invention a sticker is temporarily glued on the surface of the orthodics. The sticker has some tiny pointed cones or ridges on its surface where it comes in contact with the skin. This way the ski boot fitter can see the pressure profile/map of the orthodics against:
1. The bottom of the feet.
2. The bottom of the arch of the feet (where pressure needs to be moderate).
3. The edges (the periphery) of the feet.
4. The bottom of the toes.

With this embodiment the places of pressure and places of no pressure of the orthodics can be established in the weighed (standing up) and in the un-weighed (sitting position).

In another embodiment of the invention the sock is thick where the toes are. In other words, there is a thick patch (for example, quarter of an inch) sewn on top of the sock where it comes over the toe area. This thicker part of the sock allows for not only making sure that there is no pressure on the top of the toes (when no impression is seen on the top of the toe), but also to ensure there is enough space between the top of the toes and the liner of the boot or shoes. This is to allow the toes to have wiggle room. It is important to allow the skier to be able to move her or his toes around a little bit, to make her or him feel comfortable and to increase blood flow to the toes.

In yet another embodiment of the invention, the outer surface of the sock has male Velcro strips on it. Also provided are pieces of fabric of various thicknesses with female Velcro on it. After the sock is worn and then ski boots are worn, and after the ski boots are taken off and the socks are taken off, the user looks for places of no pressure, where there is supposed to be pressure (such as ankle area and top of the foot). Now the user must determine how much shim is needed to create pressure in these places. The way to do it, the female pieces of Velcro,

### SUMMARY OF THE MERTIS OF THE INVENTION

1. Ensures Toes are Protected:

This invention ensures that no pressure is applied on the toes.

2. Ensures that Toes Have Wiggle Room:

This invention ensures that toes have enough wiggle room. This is useful for both adults and children. Sometimes, the boots are being fitted for children, who may not be able to communicate whether they have enough wiggle and play room in the toe area. It is very comfortable and comforting to have enough space around the toes to move them around and get some blood circulation into them.

3. Ensures Pressure Points and Painful Points are Minimized, by Identifying Areas of Missing Pressure:

This invention will not only show where there is no pressure, but as importantly where there is no pressure. In places of the foot where uniform pressure is desired (e.g., all around the ankle area), it is possible to have a wrong fitting boot that does not apply pressure to some areas. This invention makes it possible to immediately establish where these areas of no-pressure are. This is very significant. For it is possible for a human being through sensation, to tell if there are areas of excess pressure, but it is impossible for a human being to be able to sense small areas of no pressure. After the areas of no pressure have been identified, shims are used to ensure that pressure is applied to these areas. This makes the pressure to be applied more uniformly to the foot, and as such reduces the amount of pressure all around, while providing a snug fit.

4. Identifies Areas of Excess Pressure and Painful Spots:

This is done by comparing the impressions left on the skin of the foot by a comfortable boot (for example, a boot the user had used already), to the impressions left on the skin of the foot, by the boot the skier is trying to select. If an area has more pronounced impressions then it can be a place of excess pressure and subject to milling the shell of the ski boot.

FIG. (1) shows a mesh sock.

FIG. (2) shows a cross section of a fabric of the sock that has the mesh (net) integrated into it.

FIG. (3) shows pointed cones, or lines for places on the skin where it is more difficult to leave impressions.

FIG. (4) shows a sock with a mesh attached to the inner surface of it. The toe area is shown made with thick material to ensure wiggle room for the toes are provided.

FIG. (5) shows how a cushion can be created to isolate and protect an area from pressure. The area could be place of an injury, or it can be a callus or a corn for example. The inventive idea is to have the cushion attached to the inner surface of the sock as opposed to the skin. This method is also useful to determine the size, shape and thickness of the shim needed in places where pressure is missing.

FIG. (6) shows how the cushion can be attached to the inside of the sock.

### THE METHOD

A typical method of determining the pressure points on the foot is to have the user:
A. Wear the socks.
B. Wear the ski boot.
C. Close the buckles (at minimum setting. This is important since at high settings pressure gets applied everywhere and one does not get the picture of what is really happening. At lower settings it is easier seen the places where pressure is not applied where it should be applied. Any asymmetrical pressure is also easier detected at lower buckle settings. For example if one side of the ankle is experiencing more pressure than the other side, lower buckle settings are more likely to expose this asymmetry).
D. Wait for several minutes. (ideally with the skier in sitting down position to see if the orthodics is applying any pressure or if it has any contact with the bottom arch of the foot).
E. Take off the boot and the sock quickly.
F. Look for the impressions/indentations/grooves left on the skin. Where there is no impression left, there is no pressure and where the impressions are small, there is little pressure, and where there are deep impressions, there is greater pressure.
G. Expand or shave the plastic of the boot, or expand, shave, or mill the liner to eliminate the pressure points. And add padding or inject foam to where there is no pressure and pressure should be in order to create a uniform and symmetrical pressure where pressure needs to exist between the boot and the foot.
H. Repeat the above process until pressure points and pressure “holes” (areas of no pressure where there should be pressure and contact between the boot and the foot) are eliminated.

The recommended method is to start seeing the pressure profile/map on the feet with the least amount of pressure. That means buckles set at minimum tightness and the person sitting down. First examination of the foot must check for the pressure of the foot a the bottom of the foot where it comes in contact with the orthodics in the un-weighed position (i.e., sitting down).

Then the buckles are tightened progressively and to see how the pressure profile changes with tightening of the buckles. Each time regions of pressure are drawn using a felt tip pen for example, and a picture is taken.

The final one is to stand up with both ski boots on and the buckles in close to maximum closure position.

The above process should be repeated after the skier wears the boots and skis with them on the slopes and then takes the boots and the socks off.

The above process could be done many times, about five times, for example, each time with the buckles successively increased in tightness. Then a picture is taken to know how the buckling force changes the pressure profile on the foot. It is also important to know what the pressure profile is even when all buckles are in the least closed position (at minimum setting). Ideally when all the buckles are in this position, there should be little pressure, and the boot must be in a most comfortable position, and full blood flow should be provided to the foot. This buckling position is especially nice to know, when one is sitting in the chairlift, and needs to relax the foot and give the foot a break, and provide it maximum breathing, comfort, and blood so the skier is better ready for more skiing the next run.

The above process determines how much the boot must be expanded and/or how much the lining must be shaved off. It also determines the bucking position for each of the buckles of the ski boots.

### OTHER EMBODIMENTS OF THE METHOD AND THE APPARATUS

1. Instead of a wire mesh, a sock can be made which has an inner surface that is corrugated. In other words, it has raised lines on the inner surface. These lines can be made of nylon strings, for example. The thick nylon strings (like a fishing line), can also be embedded into the sock and be sandwiched between two layers of fabric, for example.
2. The method of visual inspection of the impression left on the skin of the foot can be improved by two means. First is to also check and look for red and white surfaces on the skin. It is known that when pressure is applied to the skin, it turns white due to reduced blood flow (applying pressure on the skin with a clear glass and looking through the glass and seeing how the color of the skin turns white, clearly shows this phenomenon). A photograph can be taken of the foot and digitally enhanced and/or modified to accentuate the red and white areas on the skin. As the boot fitter makes adjustments to the boot, more pictures can be taken progressively to see how the pressure is changing. The picture taken can also be an infrared type picture to see the hot and cold spots of the foot as they correspond to areas of high and low blood flow. The second method of aiding and improving the visual inspection is to use a soft pasty plaster like material like clay and applying it on the skin immediately after the socks have been taken off to create a negative record of the impressions left on the foot. The plaster must be quick hardening to take a negative of the impressions before they are lost. Again, as the boot fitter changes the pressure points on the boot, more negatives of the foot could be taken to see how the pressure profile is changing.
3. A zipper, lace, or snap-on buttons can be provided on the sock (for example, extending from the lower shin area to the toes) to facilitate putting the socks on and taking them off.

Obviously the method and apparatus disclosed herein are not limited to ski boots. These methods and apparatuses would work perfectly well and be just as effective for any type of athletic or non-athletic shoe, boot, or footwear. Examples are these footwear are tennis shoes, snickers, hiking boots, running shoes, snow boarding boots, figure skates, hockey skates, or in-line skates (also known as Rollerblades).

The above invention can be either used in ski shops or places where athletic shoes are sold, or the sock can be sold in retail stores so people themselves can use and determine the pressure points on their foot by their shoes or boots and to determine the best and the ideal way to lace their shoes or buckle their boots.

I claim

1. The method of:
(a) Wearing a sock capable of leaving impressions on the skin of a human foot, when pressed against the skin,
(b) Wearing a shoe over said sock,
(c) Taking the shoe off,
(d) Taking the sock off,
(e) Visually inspecting the impressions left on the skin of the foot by the sock, to determine pressure points imposed by the shoe on the foot.
Whereby, it can be determined what areas of the foot the shoe is applying pressure on, and what areas of the foot the shoe is not applying pressure on, in order to select or make the best possible fitting shoes or boots.

2. A sock with:
A net woven to its inner surface
Whereby, this net will leave an impression on a human skin when a boot or a shoe applies pressure to it.

3. A sock with:
(a) A net woven to its inside surface,
(b) A thick material at the upper toe area
Whereby, it can be determined that not only there is no pressure being applied to the toes, but that the toes have room to freely move inside the shoe.
